(19) United States
(12) Patent Application Publication
(10) Pub. No.: US 2003/0231845 A1
(43) Pub. Date: Dec. 18, 2003

(54) Methods of processing of air-clad and photonic-crystal fibers

(76) Inventors: Anatoly Patlakh, Holon (IL); Vitaly Prosentsov, Rehovot (IL); Jacob Shai Rand, Herzelya (IL); Refael Bronstein, Kefar-Sava (IL)

Correspondence Address: ANATOLY PATLAKH, RAYTEQ PHOTONIC SOLUTIONS LTD., 7 OPPENHEIMER STREET, REHOVOT, 76701, IL

(21) Appl. No.: 10/170,692

(22) Filed: Jun. 14, 2002

(51) Int. Cl. G02B 6/20

(52) U.S. Cl. 385/125

(57) ABSTRACT

A method of processing of air clad and photonic-crystal fibers enabling fiber cleaving, splicing and polishing is disclosed. Collapse of air channels, which are part of an air-clad fiber supports the processing techniques. The methods also provide means for heat generated by laser radiation at the spliced section of an air-clad fiber with conventional fiber collection and utilization.

### FIELD OF THE INVENTION

The present invention relates to air-clad and photonic-crystal fibers, and, more particularly, to methods of processing and connecting such fibers to photonic devices and optical transmission networks.

### BACKGROUND OF THE INVENTION

Optical fibers are used to transmit optical signals in optical communication networks. Networks typically involve large assemblies of signal sources and receivers, optical fiber transmission lines, optical switches, optical amplifiers and repeaters, multiplexers and de-multiplexers, signal drop-down points, and other photonic elements as required for efficient network operation.

In order to attain proper optical network functioning, different components of the network are connected to each other in ways that facilitate optical signal generation, transmission, and amplification without incurring excessive signal loss.

Connections between fiber lines may be of the “splice” type, where one fiber is physically fused into another fiber. To allow repetitive connect-disconnect operations, optical fiber connectors are used. Optical amplifiers and lasers are made of specially doped fibers. In all of the above cases, the fiber should be cut or cleaved and its end-face processed or prepared in accordance with application requirements. Processing may include polishing, bonding to a ferrule or to other required photonic elements.

Conventional fibers are solid elements, and even when they are made of a number of coaxial glass cylinders, such as double and multi clad fibers there are no voids between the glass cylinders. FIG. 1 shows a cross-section of a conventional optical fiber, with a core 100 and a cladding 102. Cleaving, splicing, polishing, and other processing methods of these fibers are well developed and commercially available.

Conventional fibers have however, some limitations related to their numerical apertures possible, transmission losses, single mode conducting core diameter, and others. Recently introduced are the so-called “air-clad” fibers, as disclosed in U.S. Pat. No. 5,907,652. Air-clad fibers (ACF) have a larger numerical aperture than conventional single mode fibers, enabling higher power densities to be introduced into the fiber core. They have lower transmission losses and allow longer lines to be build without additional signal amplifications. Air-clad fibers conduct single-mode optical signals with lower losses and allow larger effective diameters for easy coupling of pumping sources.

FIG. 2 shows the cross-section of a multi mode air-clad fiber 110 with a single-mode fiber core 112, an inner cladding 114, an air cladding 116, and an outer cladding 118. Air cladding 116 is made of hollow glass or silica glass capillaries with inside diameters ranging from a fraction of a micron to about four or five microns. Walls dividing the space between the air channels (or “pores”) have a typical thickness less than one micron. Fiber core 112 may be doped with rare earth elements.

Photonic-Crystal Fibers (PCF's) are air-clad fibers (ACF) having air channels arranged periodically according to a grid scheme, and are described in PCT/GB00/00600 published as International Publication Number WO 00/49436, and PCT/GB00/01249 published as International Publication Number WO 00/60388. PCF's have properties similar to air-clad fibers, although the radiation conducting mechanism is different, and allow the transmission of even higher energy densities. FIG. 3 shows the cross-section of a photonic-crystal fiber 124 as disclosed in International Publication Number WO 00/49436. Fiber 124 has a single mode fiber core 126, a photonic-crystal structure assembled of hexagonal silica glass canes. A typical hexagonal cane has a cylindrical hollow center 128 and a glass wall 130 juxtaposed with other hexagon canes. An outer cladding 134 may reinforce the fiber structure. Hexagonal silica glass canes have inside diameters ranging from a fraction of a micron to about four or five microns. Walls between the hexagonal silica glass canes have a typical thickness less than one micron.

The term “air-clad optical fiber” herein denotes, without limitation, any optical fiber having air channels or open pores of any kind, including, but not limited to, photonic-crystal fibers.

Despite the advantages of the air clad and crystal fibers, the present inventors have realized that it is often very difficult and sometimes impossible to process them properly. The term “process” herein denotes, without limitation, any operation such as cleaving, splicing, polishing, bonding and others as may be required to be applied to optical fiber having air channels or open pores of any kind, including, but not limited to, photonic-crystal fibers.

Since there is no direct (physical) contact between the outer cladding and inner cladding, during cleaving and polishing, the fragile glass walls of the air cladding capillaries are easily broken, and the inner clad structure at the formed fiber end-face is damaged. In addition, debris from the polishing process, such as slurry, particles of polishing paper, and other residuals remain in and clog the air channels or pores of the polished fiber end-face (tip). This material adversely affects the effective refractive index and significantly reduces the fiber's numerical aperture. Cleaning of the end-face (tip) of the optical fiber during maintenance is also problematic as the cotton swab wetted with a cleaning agent, such as alcohol, can leave lint or other contaminants in the pores of the air channels.

Splicing of the air clad and crystal fibers using existing equipment is nearly impossible since conventional fiber splicing equipment aligns the fiber to be spliced by aligning their cores. Air clad and photonic crystal fibers do not have a clear defined core or the air channels obstruct reliable detection of such core.

Air-clad fibers enable higher, than conventional fibers, power densities to be introduced into the fiber core, and conducted along the fiber. This is one of the reasons air-clad fibers are used in optical amplifiers and fiber lasers. One of the major problems with air-clad and photonic-crystal fibers in such application is their subsequent connection to a conventional fiber. High pumping power densities propagating from an air-clad fiber with high numerical aperture into a core and cladding of conventional fiber with lower or similar numerical aperture partially escape at the spliced section and can cause burning of the polymeric buffer coating of the conventional fiber and even damage the fiber. A similar problem occurs when splicing of an air-clad fiber laser or amplifier (active ACF) with another radiation conducting air-clad fiber (passive ACF) takes place. The passive fiber may be for example a pigtailed laser source.

The excessive heat dissipated in the spliced section causes need for heat evacuation means, complicates products design and increases cost. Useful signal energy is wasted and additional optical amplifiers down the communication line are required.

Like other fibers ACFs are mounted in optical connectors enabling multiple connect-disconnect operations. Polishing of the end-faces of the ACFs enables more efficient radiation intensity coupling to the fiber. Provisional U.S. Patent Application No. 60/327,776 to the same assignee, which is incorporated by reference for all purposes as if set forth fully herein, discloses a method of processing and in particular polishing of an air clad and photonic-crystal fiber end-faces. This patent application does not indicate a way or a method of controlling the position of air-channels within a ferrule in which the air-clad fiber is inserted for polishing and connector mounting.

There is thus a need for a method of processing that enables air-clad and photonic-crystal fibers cleaving without damaging the inner clad structure at the newly formed fiber end-face.

There is need for a method of splicing air-clad and photonic-crystal fibers with other air-clad and photonic-crystal fibers and conventional fibers without significantly degrading the quality of the processed section.

There is an additional need for a method of dissipating the radiation energy induced heat in a spliced section of an air-clad with another air-clad fiber and of an air-clad with conventional fiber spliced section. There is also a need for potential utilization of optical pumping energy dissipated at the spliced fiber section.

There is further a need for a high-yield, controllable and repetitive method of processing air clad and photonic-crystal fiber end-faces, and there is a need for a method of reliably measuring the end-faces processing results and in particular the results of polishing the end-faces.

There is moreover an additional need for a method of defining the position of inserted into a ferrule air channels of an air-clad and photonic-crystal fiber. These goals are met by the present invention.

### SUMMARY OF THE INVENTION

An objective of the present invention is to provide a method of processing of air-clad and photonic-crystal fiber compatible with the existing conventional fibers processing methods.

An additional objective of the present invention is to provide a method of cleaving of air clad and porous fibers and photonic crystal fibers.

A yet another object of the present invention is to provide a method of splicing of air clad and porous fibers with collapsed air clad or photonic fibers, and with conventional fibers.

An additional objective of the present invention is to provide a method of dissipating the heat induced by laser radiation energy propagating from the air-clad fiber through the spliced section into a conventional fiber section or into a section of spliced air-clad fiber. The terms “laser radiation” and “light radiation” and accordingly “laser source” and “light source” in the context of the present invention have the same meaning.

Another objective of the present invention is to provide a method of utilization of optical pumping energy escaping or dissipated at the spliced fiber section.

An additional objective of the present invention is to provide a high-yield, controllable and repetitive method of processing air clad and photonic-crystal fiber end-faces. The method should also enable a reliable measurement of the air clad and photonic-crystal fiber end-faces processing results.

A further objective of the present invention is to provide a method of defining the position of inserted into a ferrule air channels of an air-clad and photonic-crystal fiber.

The present inventors have realized that the above objectives may be achieved by collapsing the air channels and pores in a section of an air clad and photonic-crystal fiber to be processed.

An air-clad optical fiber to which such collapsing has been applied is herein denoted as “collapsed,” and collapsed air-clad optical fibers include, but are not limited to, air-clad optical fibers having air-channels or pores that are closed, and/or collapsed. The term “air channel” herein denotes any void in an optical fiber, including, but not limited to hollow capillaries and hollow pores. The term “end-face” herein denotes the surface of either of the ends of an optical fiber, including the material of the optical fiber to a depth in which optical effects are negligible. The term “conventional fiber” herein denotes any glass or silica fiber having a solid core and a solid clad that do not have any voids, and having suitable physical and optical properties for attachment to the end-face of an air-clad or photonic-crystal fiber.

According to one of the exemplary embodiments of the present invention, the above objectives may be achieved by collapsing the air-channels of an air-clad optical fiber, in a section of it by utilizing a method, which includes the steps of:

a) selecting a section in the air-clad fiber, where said air channels collapse has to be performed said air-clad fiber having a first end and a second end, and a polymeric buffer coating;

b) stripping said polymeric buffer coating of said selected section of the air-clad fiber;

c) applying localized heat to said stripped section of said air-clad fiber, and

wherein localized heat collapses said air channels in the selected section of said air-clad fiber;

In accordance with this exemplary embodiment of the present invention said collapse of air channels of an air-clad fiber in a section of the fiber may be performed by a heat source such as an electric arc, or a filament or a laser.

In accordance with another exemplary embodiment of the present invention said collapse of air channels of an air-clad fiber in a section of the fiber may be performed by a heat source such as light radiation or laser radiation. The method of collapsing air channels of an air-clad fiber in a section of the fiber using laser radiation further comprises steps of:

a) selecting a section in the air-clad fiber, where said air channels collapse has to be performed, said air-clad fiber having a first end and a second end, and a polymeric buffer coating;

b) stripping said polymeric buffer coating of said selected section of said air-clad fiber;

c) introducing laser radiation absorption centers (nodes) in said stripped section of said air-clad fiber;

d) coupling to one of the said air-clad fiber end-faces high power laser radiation;

e) absorbing at least a portion of said high power laser radiation by said laser radiation absorption centers (nodes) in a section of said air-clad fiber, and

wherein heat generated by said absorbed laser radiation collapses said air channels in a section of said air-clad fiber.

In accordance with the exemplary embodiment of the present invention said collapse of air channels of an air-clad fiber may optionally be performed in any section of an air-clad fiber, which is located between the first and the second end-faces (tips) of said air-clad fiber. The section of an air-clad fiber, where collapse of air channels may be performed optionally and preferably includes sections that are substantially close to one of the end-faces (tips) of said air-clad fiber.

According to an additional exemplary embodiment of the present invention said collapse of air channels of an air-clad fiber may optionally be performed at both first and second end-faces of the fiber. The method of collapsing air channels of an air-clad fiber at the first and at the second end-faces, further comprises steps of:

a) collapsing said air channels at the first end-face of said air-clad fiber;

b) creating lower than atmospheric pressure in said air channels of said air-clad fiber, and

wherein the air channels at said second end-face of the fiber are collapsed when the pressure in said air channels is below the atmospheric pressure.

In accordance with an additional exemplary embodiment of the present invention said collapse of air channels of an air-clad fiber may optionally be performed at both first and second end-faces of the fiber. The method of collapsing air channels of an air-clad fiber at the first and the second end-faces, further comprises steps of:

a) collapsing said air channels at the first end-face of said air-clad fiber;

b) creating higher than atmospheric pressure outside said air channels of said air-clad fiber, and

wherein said air channels at said second end-face of the fiber are collapsed when the pressure outside of said air channels is higher than the atmospheric pressure;

The present invention enables cleaving of air clad and porous fibers. According to one of the exemplary embodiments of the present invention the method of cleaving of an air-clad fiber, comprises steps of:

a) selecting a section of said air-clad fiber where said cleaving has to be performed;

b) collapsing the air channels along the length of said section of said air-clad fiber;

c) converting by collapsing air channels said section of said air-clad fiber into a conventional fiber, and

wherein said cleaving of said air-clad fiber is performed in a conventional way in said section with collapsed air channels;

In accordance with the above method of cleaving of an air-clad fiber the collapse of air channels is performed by a source of heat. The source of heat may optionally be an arc, a filament or laser radiation.

Air clad and porous fiber splicing is an additional process enabled by the present invention. According to another exemplary embodiment of the present invention the method of splicing of an air-clad fiber, said air-clad fiber having a first end-face and a second end-face, and a polymeric buffer coating, comprises steps of:

a) selecting said air-clad fiber end-face (tip) to be spliced;

b) stripping said polymeric buffer layer of said fiber in a section substantially close to said air-clad fiber end face (tip);

c) collapsing the air channels in said stripped section substantially close to said air-clad fiber end face (tip) to be spliced on a length required for splicing, and

wherein splicing of said air-clad fiber is performed in a conventional way utilizing said section with collapsed air channels.

The exemplary method of splicing an air-clad fiber optionally and preferably enables splicing of an air-clad fiber with another air-clad fiber and splicing of an air-clad fiber with a conventional fiber.

According to yet another exemplary embodiment of the present invention, the objective of radiation induced heat dissipation in a spliced section of a conventional fiber spliced with an air-clad fiber may be achieved by utilizing a method, which includes the steps of:

a) splicing said conventional fiber with an air-clad fiber;

b) providing a beaker like vessel, filled in with a fluid having the index of refraction greater than or equal to the index of refraction of the outer cladding of said conventional fiber;

c) submersing said splice (350) and a section of said conventional fiber immediately following said splice (350) in said fluid;

d) sealing said beaker with the fiber and the fluid, and

wherein said heat induced by radiation propagating from said air-clad fiber into said conventional fiber is partially dissipated and absorbed by said fluid.

In accordance with another exemplary embodiment of the present invention, the objective of radiation induced heat dissipation in a spliced section of a conventional fiber spliced with an air-clad fiber may be achieved by utilizing a method, which includes the steps of:

a) selecting said air-clad fiber end face (tip) to be spliced;

b) creating local radiation dissipating centers (nodes) in a section of fiber substantially close to said air-clad fiber end face;

c) splicing said conventional fiber with an air-clad fiber, and

wherein said heat induced by radiation propagating from said air-clad fiber into said conventional fiber is partially dissipated by said local radiation dissipating centers.

According to further exemplary embodiment of the present invention, the objective of radiation induced heat dissipation in a spliced section of a conventional fiber spliced with an air-clad fiber may be achieved by utilizing a method which comprises the steps of both submersing the spliced section of the conventional fiber into an index matching fluid and creating radiation dissipating nodes in a section of the air-clad fiber substantially close to the splice. In accordance with this embodiment, the radiation induced heat is dissipated by said radiation dissipating nodes and said fluid.

Present invention provides a method of pumping a fiber laser or a fiber amplifier by escaping at the spliced section of an air-clad fiber with conventional fiber pumping energy. In accordance with the exemplary embodiment of the present invention the method comprises steps of:

a) splicing an air-clad fiber with a conventional fiber;

b) submersing said spliced section in a fluid having index of refraction greater than or equal to the index of refraction of the outer cladding of said spliced fiber, said fluid placed in a vessel/volume surrounding the fiber and having with it a common axis;

c) bending said spliced fibers to a curvature causing excessive radiation power loss into said surrounding fluid;

d) capturing radiation power dissipated in the fluid at said fiber bend and at the splice, and

wherein said captured in the fluid dissipated radiation power is utilized to pump at least one additional laser amplifier.

According to yet additional exemplary embodiment of the present invention, the objective of measuring the thickness of polished sealed end-face of an air-clad fiber may be achieved by utilizing a method, which includes the steps of:

a) collapsing air channels in said air-clad fiber, where said air channels collapse seals said end-face of said air-clad fiber;

b) polishing said sealed end-face;

c) focusing a microscope in a first plane where said polished surface of said sealed end-face is located;

d) refocusing microscope in a way that the not collapsed portions of air channels of said air-clad fiber are in the focal plane (second focal plane) of the microscope

e) measuring the distance between said first focal plane of the microscope and said second focal plane of the microscope, and

wherein said measured distance represents the thickness of the sealed and polished portion of said air-clad fiber.

An advantage of the described methods is that the collapsing of air channels of an air clad or porous fiber in a section of fiber forms a section of conventional fiber of the same material as the fiber and no additional parts, elements, or substances are used in the method. Under such conditions, the collapsed section of the fiber may be processed utilizing existing optical fiber processing methods.

A further advantage is provided by the method of present invention, if the collapsing of air channels is performed at both end-faces of an air-clad or photonic-crystal fiber. According to the present invention, penetration of humidity, dust, and other contaminants into an air-clad or photonic-crystal fiber is prevented by treating both end-faces of the fiber in the manner described above.

The methods as described above provide advantages over the prior art in that the cleaving of the fiber is done on a section of fiber that has no air channels and hence no damage to the fragile air channel walls and to inner cladding is cased. Splicing of the end of the fiber is done on a section of fiber that also has no air channels and hence enables use of existing fiber splicing equipment and splice alignment techniques.

In addition, the present invention offers another advantage in that it is possible to absorb or dissipate the excessive energy generated by laser pumping radiation propagating from the air-clad fiber through the spliced section into a conventional optical fiber or into another air-clad fiber. The excessive energy is dissipated or absorbed significantly reducing the power density in the conventional fiber and lowering the risk of damage caused by excessive laser power to the conventional fiber or other components connected or located close to them.

An additional advantage of the invention is that it enables collection of the laser pumping radiation escaping at the spliced section of an air-clad fiber with a conventional fiber. Collected radiation is used to pump an additional optical amplifier or fiber laser reducing the number of laser pumps required and providing significant savings.

The present invention also provides a reliable and repetitive technique for measuring the results of processing e.g. polishing of an air-clad or photonic-crystal fiber article having its end-face sealed, and positioning the polished end-face within a ferrule. The polishing of a sealed end-face of an air-clad fiber may be performed in a conventional way.

The disclosed above methods of processing air clad and porous fibers by collapsing their air channels do not adversely affect the path of light exiting or entering the fiber.

### BRIEF DESCRIPTION OF THE DRAWINGS

The invention is herein described, by way of non-limiting example only, with reference to the accompanying drawings, wherein:

FIG. 1 is a transverse cross-section of a conventional prior art optical fiber structure.

FIG. 2 is a transverse cross-section of a prior art air-clad optical fiber structure.

FIG. 3 is a transverse cross-section of a prior art photonic-crystal fiber structure.

FIGS. 4A-4D are longitudinal cross-sections of an air-clad fiber, illustrating steps in an exemplary embodiment of a method of collapsing air channels in a section of a fiber between the first and the second end-faces of the fiber.

FIG. 5 is a longitudinal cross-section A-A of the fiber of FIG. 2, illustrating collapsed air channels substantially close to the end-face of the fiber.

FIGS. 6A-6C illustrate steps comprising the method of collapsing air channels in an air-clad fiber by laser radiation propagating along the fiber.

FIGS. 7A-7C illustrate an air-clad fiber having both end-faces of it collapsed.

FIGS. 8A-8C shows steps in a method of cleaving a section of an air-clad fiber.

FIGS. 9A-9B illustrates steps in a method of splicing of an air-clad fiber with a conventional or another air-clad fiber.

FIGS. 10A-10C illustrate a method of escaping laser pump energy dissipation in a spliced section of an air-clad fiber with a conventional fiber or collapsed air-clad fiber.

FIG. 11 illustrates another method of escaping laser pump energy dissipation in a spliced section of an air-clad fiber with a conventional fiber or collapsed air-clad fiber.

FIG. 12 illustrates an additional method of escaping laser pump energy dissipation in a spliced section of an air-clad fiber with a conventional fiber or collapsed air-clad fiber.

FIG. 13 illustrates a method of utilization of escaping laser pump energy dissipation in a spliced section of an air-clad fiber with a conventional fiber for pumping an additional laser amplifier.

FIG. 14 illustrates a method of measuring the thickness of collapsed and polished part of an air-clad fiber inserted in a ferrule.

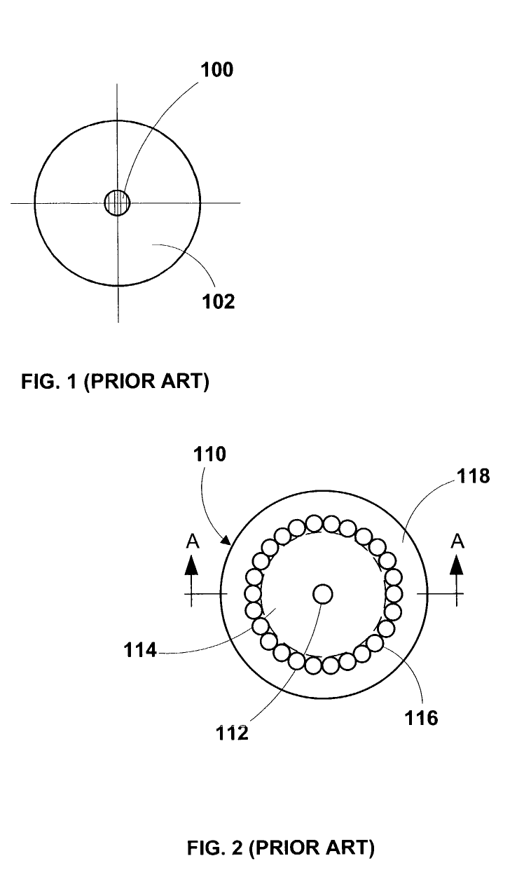

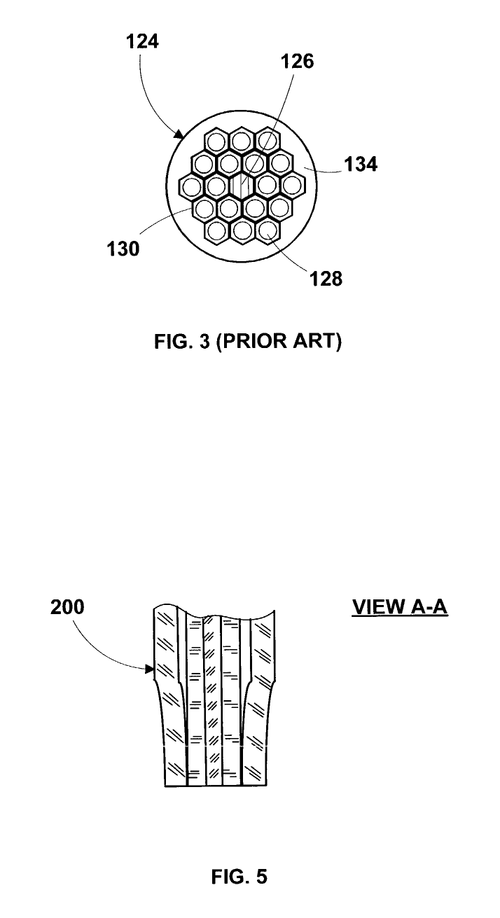

### DESCRIPTION OF THE EXEMPLARY EMBODIMENTS

The principles and execution of methods of processing of air-clad fibers according to the present invention, and the operation and properties of a resulting fibers produced thereby may he understood with reference to the drawings and the accompanying description of non-limiting, exemplary embodiments.

Air Channels Collapse

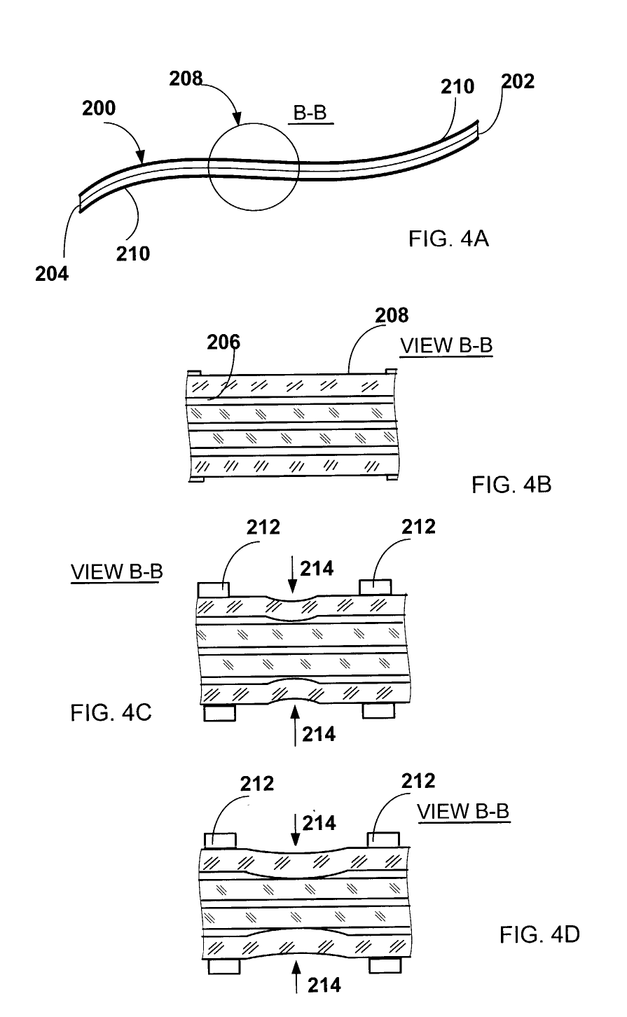

FIG. 4 is a longitudinal cross-section of an air-clad fiber, illustrating steps in an exemplary embodiment of a method of collapsing air channels in a section of a fiber between the first and the second end-faces of the fiber.

According to this particular exemplary embodiment of the present invention, the air-clad fiber 200 has a first end-face 202 and a second end-face 204, and a protective polymeric buffer coating 210. In accordance with present invention for collapse of air channels 206 in a section 208 of fiber 200 fiber 200 is optionally and preferably stripped at selected section 208 of its protective polymeric buffer coating 210. Stripping of the coating may be performed in any known manner. Air channels 206 are optionally and preferably collapsed by localized application of heat. For localized application of heat stripped section 208 of fiber 200 is mounted on a regular fiber splicer 212 such as Furukawa model FSM—40S or any other and arc 214 is activated. Localized heat generated by arc 214 gradually melts part of a section 208 of fiber 200 and collapses air channels 206. A filament (not shown) such as one of a Vytran model FFS—2000 splicer, commercially available from Vytran Corporation, Morganville, N.J. 07751 USA instead of an arc may alternatively be used as a source of heat for the collapse of air channels 206. In a similar way, a CO₂ laser focused on the fiber may produce collapse of air channels 206.

In order to avoid thermal shocks to the fiber and gain better control over the process of air channels 206 collapse arc 214 is activated a number of times until successful result is achieved. The process and result of collapse of air channels 206 may optionally monitored with the help of viewing and monitoring devices available on the splicer.

The length of the collapsed section may be optionally regulated by moving the source of heat for example arc 214 relative to the fiber 200 or vise versa and activating the source of heat at each new position or increasing the power of the heating source. Proper selection of each successive position ensures the continuity of the air channels collapse.

In a similar manner, air channels may be collapsed at any section of an air-clad fiber. FIG. 5 is a longitudinal cross-section A-A of the fiber of FIG. 2, illustrating collapsed air channels 206 substantially close to one of the end-face of air-clad fiber 200.

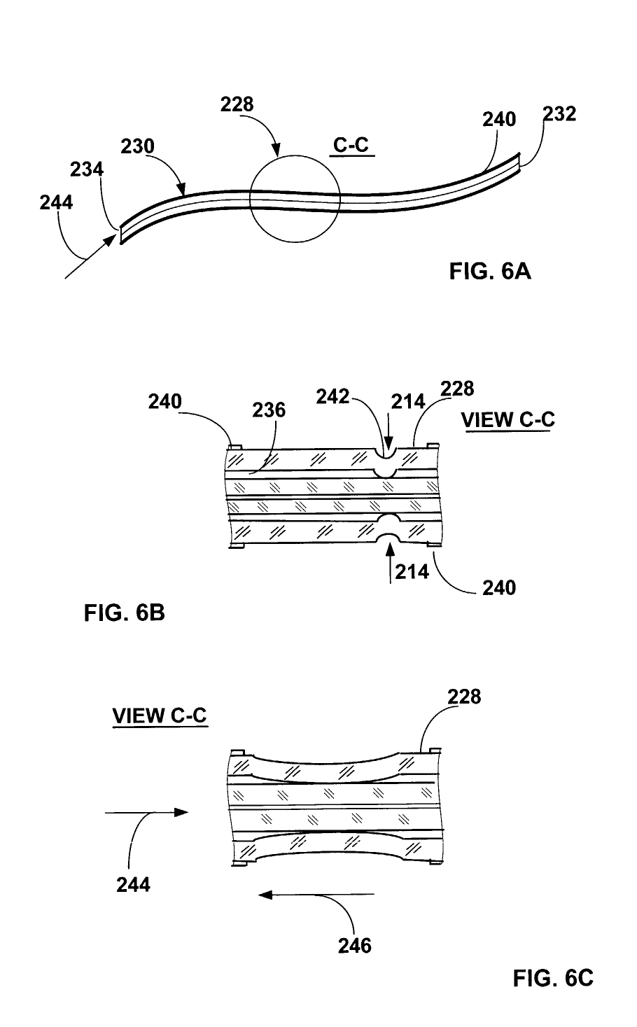

In accordance with another exemplary embodiment of the present invention collapse of air channels of an air-clad fiber in a section of the fiber may be performed by a heat source such as laser radiation. FIGS. 6A-6C illustrate steps comprising the method of collapsing air channels in an air-clad fiber by laser radiation propagating along the fiber.

In accordance with the exemplary method of the present invention is selected a section 228 of an air-clad fiber 230 where air channels 236 collapse will be performed. Air-clad fiber 230 has a first end-face 232 and a second end-face 234, and a protective polymeric buffer coating 240. Initially fiber 230 is optionally and preferably stripped at selected section 228 of its protective polymeric buffer coating 240. Stripping of the coating may be performed in any known manner. At least one laser radiation absorbing center (node) 242, which represent portion of air-clad fiber with collapsed air channels, is optionally created by any means including, but not limited to arc or filament (not shown). A high power high brightness laser source 244, such as SuperFocus, commercially available from Rayteq Photonic Solutions Ltd., Rehovot, Israel is coupled to end-face 234 of fiber 230. (Although laser source 244, is shown coupled to end-face 234 of fiber 230 it may be coupled to any of end-faces 232 or 234 of fiber 230.)

The numerical aperture of fiber 230 at the section where laser radiation absorbing node is located is smaller than at the section where non-collapsed air channels exist. Laser radiation coupled at the entrance of fiber 230 to a larger numerical aperture (air-clad fiber numerical aperture) is partially leaving (escaping the fiber) in the vicinity of laser radiation absorbing node 242 through outer cladding an partially is absorbed by laser radiation absorbing node 242. The absorbed laser radiation is heating fiber 230 further collapsing air channels 236. Arrow 246 shows the direction of air channels 236 collapse progress. By using this method, the collapse of air channels may be performed on a substantial length, without involving any mechanical movement of the fiber or of the laser source.

In accordance with the exemplary embodiment of the present invention, the collapse of air channels 236 of an air-clad fiber 230 may optionally and preferably be performed in any section of an air-clad fiber 230, which is located between the first 232 and the second 234 end-faces (tips) of air-clad fiber 230. The section of an air-clad fiber, where collapse of air channels may be performed optionally and preferably includes sections that are substantially close to one of the end-faces 232 or 234 of said air-clad fiber 230.

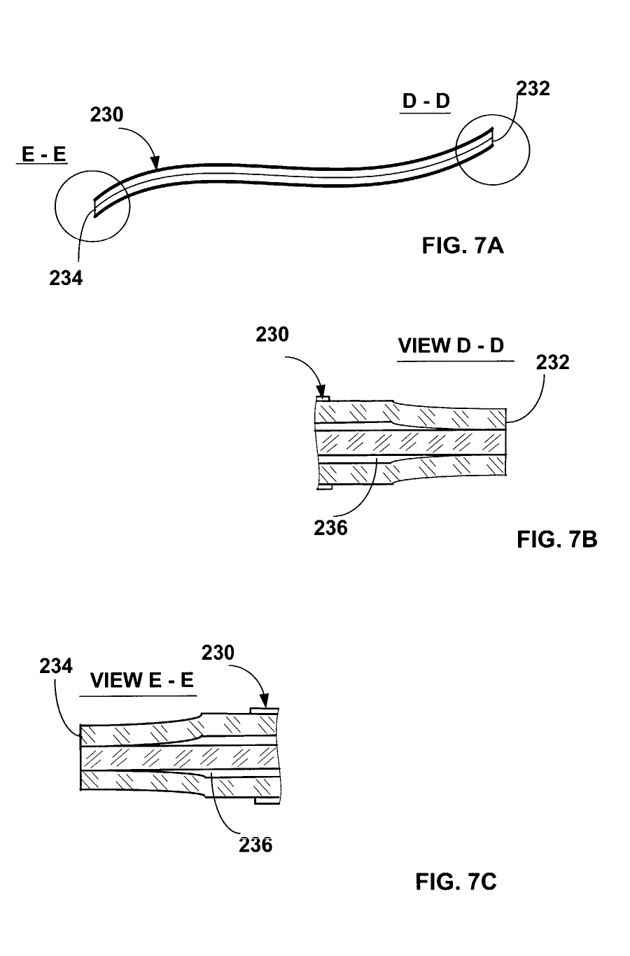

In some applications such as fiber lasers manufacture or optical amplifiers manufacture, where a certain length of a fiber typically doped by rare earth elements ions is required, there is a need to collapse air channels 236 of an air-clad fiber 230 at both first 232 and second 234 end-faces of fiber 230. FIG. 7 illustrates an air-clad fiber having both of its end-faces collapsed. The collapse of air channels 236 at one of the end-faces e.g. 232 may be performed in accordance with one of the air channel collapse methods disclosed above. Sometimes collapse of air channels 236 at a second end-face 234 cannot be performed in way similar to the collapse of air channels 236 at first end-face, since heating of second end-face heats the air located in air channels 236. Heated air located in air channels 236 expands its volume and creates excessive pressure in air channels 236. This excessive pressure warps second end-face 234 and adjacent to second end-face 234 portions of fiber 230.

According to an additional exemplary embodiment of the present invention the method of collapse of air channels 236 of an air-clad fiber 230 at both first 232 and second 234 end-faces of fiber 230 includes steps of collapsing air channels of an air-clad fiber at first end-face for example end-face 232. Following collapse of air channels 236 at first end-face 232, a pressure lower than the atmospheric pressure is created in air channels 236 of air-clad fiber 230. Collapse of air channels 236 at second end-face 234 of fiber 230 is then performed. Since the pressure in air channels 236 is below the atmospheric pressure, and heating of the fiber end does not created in this case significant pressure in the air channels, and accordingly there are no adverse effects on the fiber, its end-face, or sections of the fiber adjacent to the fiber end-faces.

Vacuum optionally may be used to create pressure below atmospheric in air channels 236 of fiber 230. This however, would complicate the equipment and respectively air channel collapse process. Optionally and preferably the pressure below atmospheric in air channels 236 of fiber 230 is created by heating fiber 230 and keeping it at an elevated temperature. Sealing of air channels at (second) end-face 234 of fiber 230 is then performed. Optionally and preferably, the sealing of end-face 234 is performed by initiating collapse of air channels 236. This initial collapse is, however, made for sealing air channels purposes only. Air channels sealing maintains lower than atmospheric pressure in air channels 236. Fiber 230 is now cooled and final collapse of air channels 236 on a desired length at second end-face 234 takes place. Final collapse of air channels 236 at second end-face 234 in this case does not cause significant pressure changes and does not cause adverse effects at second end-face 234 and adjacent to second end-face 234 portions of fiber 230.

In an alternative method of the present invention the method of collapse of air channels 236 of an air-clad fiber 230 at both first 232 and second 234 end-faces of fiber 230 includes steps of collapsing air channels of an air-clad fiber at first end-face for example end-face 232. Following collapse of air channels 236 at first end-face 232, a pressure higher, that atmospheric pressure is created outside of air-clad fiber 230. Collapse of air channels 236 at second end-face 234 of fiber 230 is then performed. The value of external atmospheric pressure is selected in a way that the changes in the pressure in air channels 236 would not cause adverse effects on the fiber or its end-face.

Cleaving of Air-clad Fiber

Cleaving of air-clad fibers is required in manufacturing of fiber lasers, optical amplifiers, insertion of a fiber into a ferrule of a connector, connection to optical networks and others. Cleaving of air-clad fiber utilizing conventional cleaving technique damages the inner cladding and walls of air channels and reduces the quality of the cleaved end-face of the fiber making it in some cases not suitable for further use. The damage of the inner cladding and walls of air channels takes place since there is no physical contact between the inner and outer claddings of the fiber.

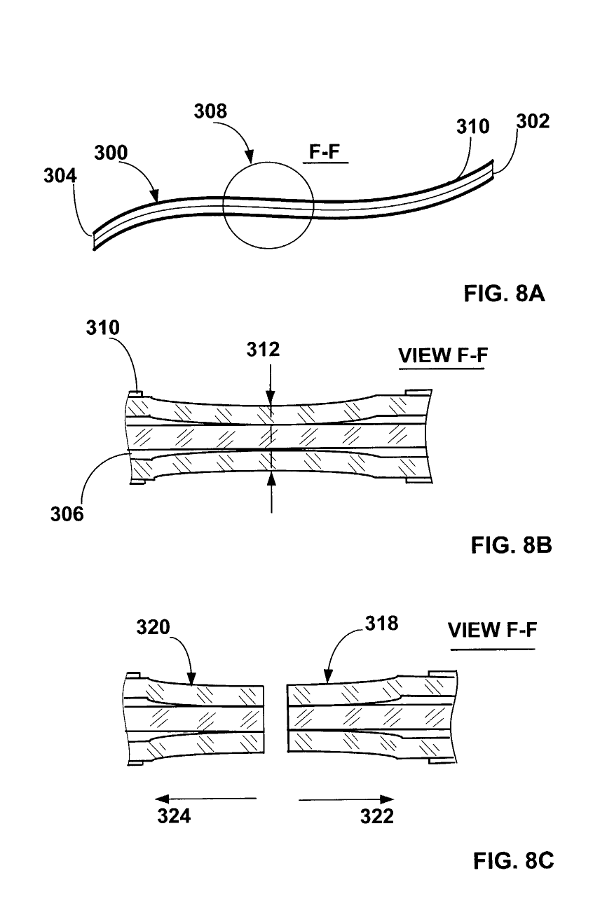

Present invention discloses a method of cleaving of an air-clad fiber illustrated in FIG. 8 that includes steps of selecting a section 308 of an air-clad fiber 300 where the cleaving will be performed. (For the simplicity of explanation in this and all further Figures the structure of air-clad fiber is shown, as a fiber comprising core, air-clad and outer clad only.) Initially fiber 300 is optionally and preferably stripped at selected section 308 of its protective polymeric buffer coating 310. Stripping of the coating may be performed in any known manner. At the next step air channels 306 are optionally and preferably collapsed by localized application of heat in accordance with any one of air channels collapse method disclosed above.

Collapse of air channels 306 in a section 308 of air-clad fiber 300 effectively converts section 308 into a conventional fiber section. Cleaving of air-clad fiber 300 optionally and preferably may be performed in section 308, converted into a section of a conventional fiber. Arrows 312 in FIG. 8B schematically illustrate the cleaving or fracture line. Following the cleaving two newly formed parts 318 and 320 of cleaved fiber 300 are pulled away as shown by arrows 322 and 324 or bending of the fiber. Cleaving performed in accordance with this method does not damage the inner cladding or the fragile walls of the air channels.

Splicing of Air-clad Fibers

Splicing of air-clad fibers is required in manufacturing of fiber lasers, optical amplifiers, connection to optical networks and others. Air-clad fibers may be spliced with another collapsed air-clad fiber or with a conventional fiber. Splicing of air-clad fiber utilizing conventional splicing technique and existing splicing devices is not possible. Alignment devices of the fiber splicers align the cores of fibers to be spliced, based on the differences of refractive indices of the core and cladding. Air-clad fibers do not show these differences and in many cases are simply not transparent to the light used for alignment purposes illumination. Photonic-crystal fibers may have no core at all. It should be noted that splicing methods based on fiber external diameter are known in the art. These methods have however lower than core based alignment accuracy and are not suitable for typically single mode air-clad and photonic-crystal fibers.

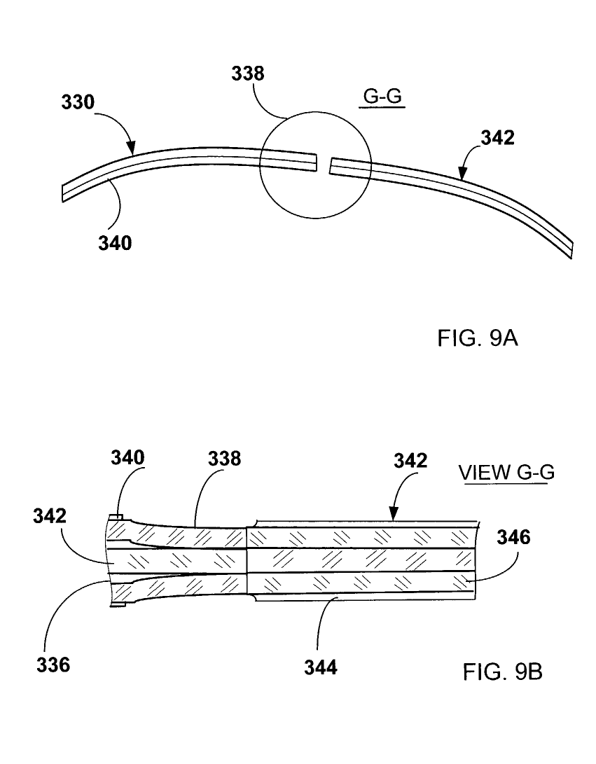

According to an exemplary method of the present invention the splicing process of an air-clad fiber illustrated in FIG. 9 includes steps of selecting a section 338 of air-clad fiber 330 where the splicing will be performed. Initially fiber 330 is optionally and preferably stripped at selected section 338 of its protective polymeric buffer coating 340. Stripping of the coating may be performed in any known manner. At the next step air channels 336 are optionally and preferably collapsed by localized application of heat in accordance with any one of air channels collapse method disclosed above.

Collapse of air channels 336 in a section 338 of air-clad fiber 330 effectively provides a section of a conventional fiber. Splicing of air-clad fiber 330 with a conventional fiber 342 may be accomplished by conventional fiber splicing tools optionally and preferably utilizing section 338. Conventional splicer such as Furukawa model FSM—40S or any other may be used for this purpose. The length of the section with collapsed air channels where the splice will be performed is selected to ensure proper splice. Numeral 344 designates protective polymeric buffer coating of conventional fiber 342.

Utilizing the method of splicing of the present invention air-clad fibers may be spliced with a conventional fiber with another collapsed air-clad fiber.

Dissipating Radiation Induced Heat Generated at the Splice of an Air-clad fiber

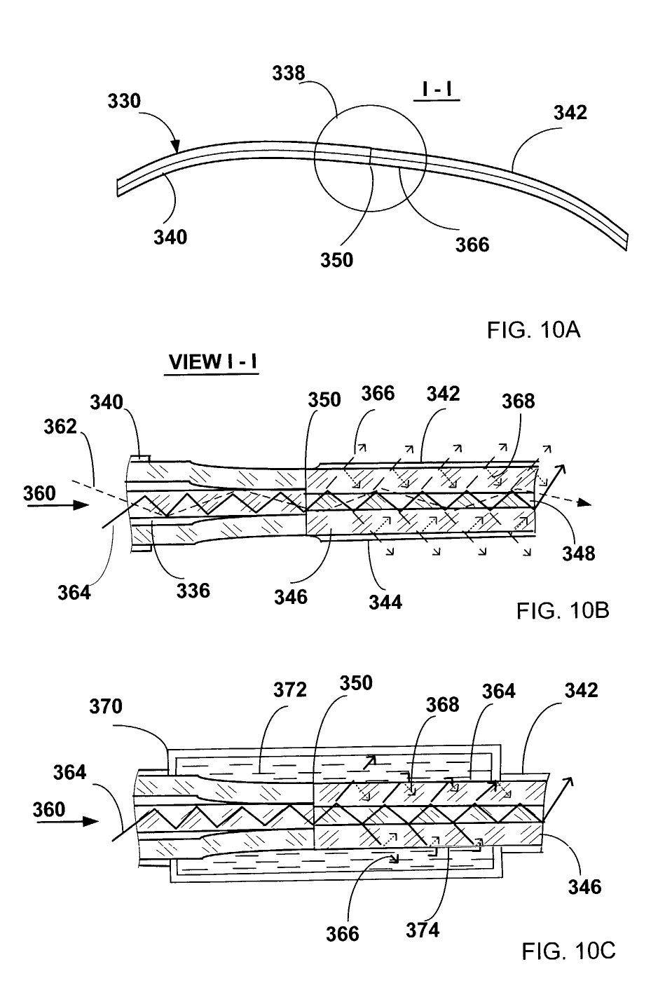

FIG. 10A shows a spliced section 338 of an air-clad fiber 330 with a conventional fiber 342. The numerical aperture of air-clad fiber 330 is substantially larger than the numerical aperture of coated conventional fiber 342. Conventional fiber may be for example such fiber as HI 1060 commercially available from Corning Corporation, Inc. Corning, N.Y. U.S.A. Numerals 344, 346, and 348 (FIG. 10B) designate respectively protective polymeric buffer coating, clad and core of conventional fiber 342.

FIG. 10B shows the process of radiation induced heat at a spliced section of an air clad fiber with conventional fiber dissipation. Laser pump radiation, shown by arrow 360 coupled to the entrance of air-clad fiber 330 propagates through spliced section 338 (FIG. 10A) into core 348 and cladding 346 of conventional fiber 342. Conventional fiber 342 captures only the radiation propagating within the angle defined by the numerical aperture of the clad-polymeric buffer coating of fiber 342. For example, the angle at which pump radiation 362 propagates matches the angle defined by the numerical aperture of the core-clad indices of fiber 342 and the radiation propagates through fiber 342 without being disturbed. The angle at which pump radiation 364 propagates exceeds the angle defined by the numerical aperture of the clad-core and that of clad-polymeric buffer coating of fiber 342. At least a portion of radiation 364 marked by numeral 366 escapes and is partially absorbed by clad 346 and partially by polymeric buffer coating 344. Absorbed portion of laser pump radiation heats polymeric buffer coating 344 melts it and damages fiber 342. A smaller portion of laser radiation marked 368 is reflected back into clad 346.

At present, in order to avoid polymeric buffer coating 344 heating and melting, coating 344 is usually stripped of a section of conventional fiber 342 immediately following splice 350. The length of the stripped section is typically 150 mm to 300 mm. Stripping of polymeric buffer coating 344 reduces, however, the quality of fiber 342, makes it prone to cracks and contacts with other materials.

Present invention provides a method illustrated in FIG. 10C of dissipation of laser pump radiation induced heat in spliced section 338 (FIG. 10A) and in a section of conventional fiber 342 immediately following splice 350 In accordance with the method of present invention, polymeric buffer coating 344 is optionally and preferably stripped of section 374 of conventional fiber immediately following splice 350. Spliced section of conventional fiber is placed in a beaker like vessel 370. Beaker like vessel 370 may be cylindrical or conical tube optionally made from glass having its outer surface not polished. Optionally the outer surface may be treated to be sufficiently rough enhancing radiation diffusion. Beaker like vessel 370 is filled in with a fluid 372 having index of refraction greater than, or equal to the index of refraction of the cladding 346 of conventional fiber 342 or outer cladding (not shown) in case of a double cladding fiber. Such fluid for example may be Glycerin, matching gel or other fluid with similar optical properties.

Beaker like vessel 370 is sealed at both of its ends in a way that stripped section 374 of conventional fiber is preferably submersed into fluid 372 or surrounded by fluid 372 in all of its residing in a beaker like vessel 370 length. Fluid 372 transmits incident laser radiation, although escaping portions 366 and 368 of laser radiation are dispersed. Beaker like vessel 370 has substantially larger cross section than conventional fiber 342 and absorbed in it laser radiation does not cause any damage. The length of beaker like vessel 370 may be reduced by providing more efficient laser pump radiation from conventional fiber escape conditions. For example, surface of stripped section 352 of conventional fiber 342 may be treated to have sufficiently rough surface enhancing radiation diffusion. The rough surface of stripped section 352 may be produced by chemical etching, sand paper, or sandblasting.

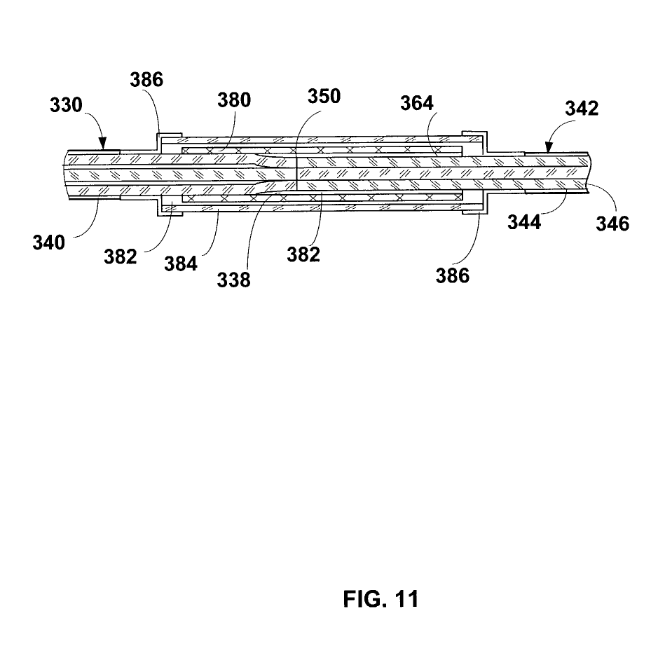

FIG. 11 is an illustration of another exemplary embodiment of a method of dissipation of laser pump radiation induced heat in a spliced section of air clad fiber 330 with conventional fiber 342 and in a section of conventional fiber 342 immediately following splice 350. In accordance with this embodiment stripped of polymeric buffer coating 344 section 374 of conventional fiber immediately following splice 350 and spliced section itself are placed in a cylindrical Teflon sleeve 380 filled in with a fluid 382. Fluid 382 preferably has index of refraction greater than, or equal to the index of refraction of cladding 346 of conventional fiber 342 or outer cladding (not shown) in case of a double cladding fiber. Such fluid for example may be refractive index matching gel, or other fluid with similar optical properties. Glass tube 384 overcoats Teflon sleeve 380. Index matching fluid further fills in the space between the walls of glass tube 384 and Teflon sleeve 380. Thermally shrinkable material 386 seals both end of the assembly.

In an alternative embodiment (not shown) of a method of dissipation of laser pump radiation induced heat in a spliced section of air clad fiber with conventional fiber and in a section of conventional fiber immediately following splice the Teflon and glass tubes are substituted by a metal tube. Metal tube, into which stripped of polymeric buffer coating section of conventional fiber immediately following splice and spliced section itself are placed, is filled in with a fluid that preferably has index of refraction greater than, or equal to the index of refraction of cladding of conventional fiber or outer cladding in case of a double cladding fiber. Both index matching fluid or gel and metal tube may optionally dissipate and absorb laser radiation induced heat. Thermally shrinkable material seals both end of the assembly.

The advantage of the disclosed method of laser radiation induced heat in a spliced section of an air-clad fiber with conventional fiber dissipation as compared to the presently existing method is the short length of the glass or Teflon tube assembly. The length of the whole assembly is typically between 40 mm to 60 mm making it attractive for use in optical networks.

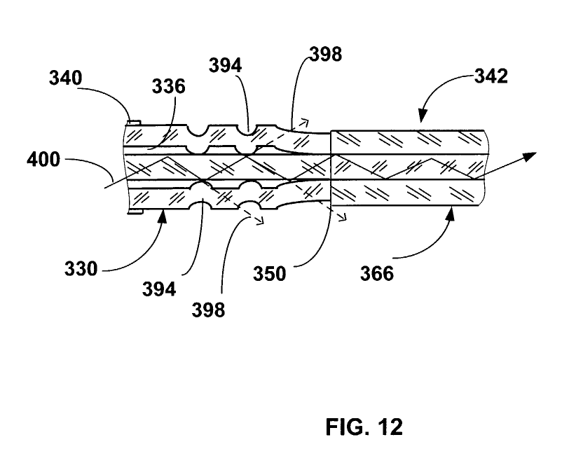

In a further embodiment, laser radiation induced heat in a spliced section of a conventional fiber 342 spliced with an air-clad fiber 330 may be dissipated and partially absorbed, as shown in FIG. 12, by providing radiation absorbing and dissipating centers 394 (nodes) in a section of air-clad fiber 330 substantially close to splice 350 of air-clad fiber 330 with a conventional fiber 342. Radiation dissipating centers 394 (nodes) optionally and preferably may be created by collapsing air channels 336 of air-clad fiber. For proper radiation energy, dissipation the physical size (length) of the nodes should substantially affect the numerical aperture of air-clad fiber. Each node 394 locally dissipates a portion 398 of propagating laser radiation 400 reducing the power and accordingly the density of radiation reaching splice 350 and propagating into conventional fiber 342.

It is clear that laser radiation induced heat in a spliced section of an air-clad fiber with a conventional fiber may be dissipated by a combination of a fluid based radiation dissipation method and radiation dissipating nodes.

Utilizing Radiation Escaping at the Splice of an Air-clad fiber

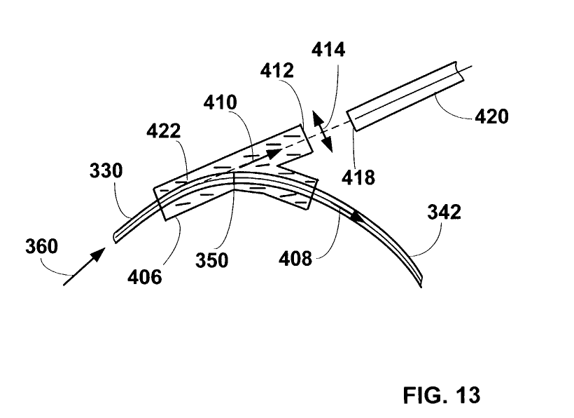

Laser radiation escaping at the spliced section of a conventional fiber 342 spliced with an air-clad fiber 330 may represent more than 50% of initially introduced into fiber laser pump energy. In accordance with another exemplary embodiment of the present invention laser radiation escaping at the spliced section of a conventional fiber 342 spliced with an air-clad fiber 330 may be collected and utilized for pumping of at least one additional optical amplifier. FIG. 13 is an illustration of a method of collection and utilization of laser radiation escaping at the spliced section for pumping at least one additional optical amplifier.

Beaker like vessel 406 in this particular case may optionally and preferably have a Y-type or a T-type form. Radiation energy coupled at the splice to conventional fiber propagates in it in the direction indicated by arrow 408. Intentionally introduced curvature assists escape of pumping energy marked by arrow 410. Arrow 360 marks pump energy launched into first laser amplifier, of which air-clad fiber 330 is a part. At end-face 412 of beaker like vessel 406, a lens 414 with suitable numerical aperture collects escaped radiation and couples it to another fiber 420. Fiber 420 is preferably a rare Earth elements doped fiber and optionally may be a fiber laser or a laser amplifier. The coupling is performed by focusing the collected energy on end-face 418 of fiber 420. Fluid 422 may fill-in both pumping radiation propagation directions 408 and 412.

Although lens 414 is shown as a separate and not connected to beaker like vessel 406 part, it optionally and preferably may be used to seal beaker like vessel 406.

Method of Polished Sealed End-face of an Air-clad fiber Thickness Measurement

A method of processing and in particular polishing of an air clad and photonic-crystal fiber end-faces is disclosed in a pending U.S. Patent Application No. 60/327,776 to the same assignee. Present invention improves the disclosed method of processing and in particular polishing of an air clad and photonic-crystal fiber end-faces by providing a controllable and repetitive method of reliably measuring the thickness of polished sealed end-face of an air-clad fiber.

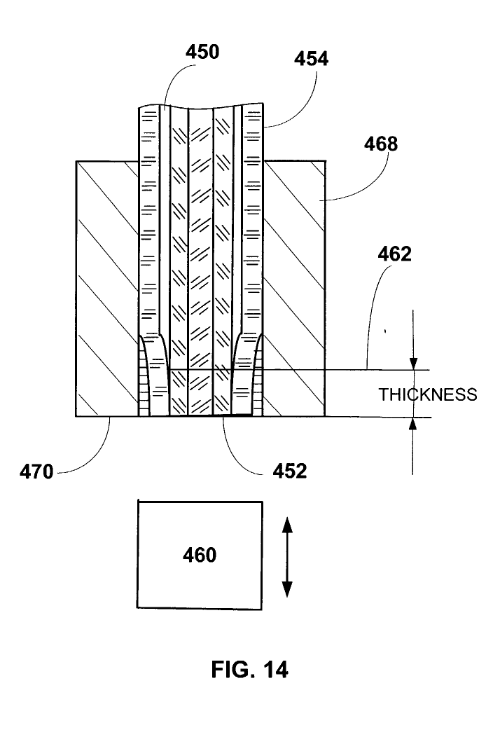

FIG. 14 illustrates the method of measuring the thickness of polished seal and position of air channels. The method of present invention includes steps of collapsing air channels 450 in a section of air-clad fiber substantially close to end-face 452 of an air-clad fiber 454. The collapse of air channels 450 of air-clad fiber 454 may be preformed by any of the described above methods. Collapsed air channels 456 seal end-face of air-clad fiber 454 and end-face 452 may be polished in a conventional way. For control purposes a microscope 460 is focused on polished end-face surface 452, termed for explanation purposes first focal plane 462, and than refocused in a way that the not collapsed portions of air channels 450 of air-clad fiber 454 are in the focal plane of microscope 460, termed for explanation purposes second focal plane. The difference in the distance between the position of the first focal plane (452) of microscope 460 and second focal plane (462) of microscope 460 represents the thickness of polished sealed part of air-clad fiber 454.

As illustrated in FIG. 14 polished surface 470 of ferrule 468 coincides with first focal plane 452. This enables in addition to the measurement of the position of not collapsed portions of air channels 450 of air-clad fiber 454 measurement of their position with respect to the ferrule plane. Polishing process removes material of both ferrule 468 and fiber 454. Control of the amount of the removed material helps to position fiber 454 at a proper depth within ferrule 468.

While the invention has been described with respect to a limited number of embodiments, it will be appreciated that many variations, modifications and other applications of the invention may be made.

We claim:

1 A method of cleaving of an air-clad fiber having an inner clad, an air-clad maid of air channels or pores, an outer clad and a polymeric buffer coating, comprising steps of:
a) selecting a section of said air-clad fiber where the cleaving has to be performed;
b) stripping polymeric buffer layer of said selected section of said air-clad fiber;
c) collapsing said air channels along the length of said stripped section of said air-clad fiber;
d) converting by collapsing of said air channels said stripped section of said air-clad fiber into a conventional fiber, and
cleaving said air-clad fiber in a conventional way in said section with collapsed air channels;

2 A method of cleaving of an air-clad fiber as in claim 1 and where collapsing of said air channels is performed by heat;

3 A method of cleaving of an air-clad fiber as in claims 1 and 2, and where said heat source is an arc;

4 A method of cleaving of an air-clad fiber as in claims 1 and 2, and where said heat source is a filament;

5 A method of cleaving of an air-clad fiber as in claims 1 and 2, and where said heat source is laser radiation;

6 A method of cleaving of an air-clad fiber as in claims 1 and 5, further comprising steps of:
a) introducing laser radiation absorption centers (nodes) in said selected section of said air-clad fiber where the cleaving has to be performed;
b) coupling to one of the said air-clad fiber end-faces high power laser radiation;
c) collapsing by heat generated by said absorbed high power laser radiation said air channels in a selected section of said air-clad fiber, and
cleaving said air-clad fiber in a conventional way in said section with collapsed air channels;

7 A method of laser radiation induced heat dissipation in a spliced section (338) of an air-clad fiber with a conventional fiber and in a section of a conventional fiber immediately following the splice (350), comprising steps of:
a) splicing said conventional fiber with an air-clad fiber;
b) providing a beaker like vessel filled in with a fluid having index of refraction greater or equal to the index of refraction of the outer cladding of said conventional fiber;
c) submersing said splice and a section of said conventional fiber immediately following said splice in said fluid;
d) sealing said beaker with the fiber and fluid, and
dissipating and absorbing said induced by radiation propagating from said air-clad fiber into said conventional fiber heat in said fluid and beaker like vessel.

8 A method of laser radiation induced heat dissipation in a spliced section of an air-clad fiber with a conventional fiber and in a section of a conventional fiber immediately following the splice as in claim 7, and where said beaker like vessel is a glass tube having its outer walls not polished.

9 A method of laser radiation induced heat dissipation in a spliced section of an air-clad fiber with a conventional fiber and in a section of a conventional fiber immediately following the splice as in claim 7, and where said beaker like vessel is a Teflon tube.

10 A method of laser radiation induced heat dissipation in a spliced section of an air-clad fiber with a conventional fiber and in a section of a conventional fiber immediately following the splice as in claim 7, and where said beaker like vessel is a metal tube.

11 A method of laser radiation induced heat dissipation in a spliced section as in claim 7 and where both spliced fibers are air-clad fibers.

12 A method of laser radiation propagating from air-clad fiber through a spliced section into a conventional fiber induced heat dissipation in a spliced section and in a section of an air-clad fiber as in claim 7, further comprising steps of:
a) selecting said air-clad fiber end face (tip) to be spliced;
b) creating radiation absorbing and dissipating centers (nodes) in a section of said fiber substantially close to said air-clad fiber end-face (tip);
c) splicing said conventional air-clad fiber with an air-clad fiber, and
wherein said heat induced by radiation propagating from said air-clad fiber into said conventional fiber is partially absorbed and dissipated by said local radiation dissipating and absorbing centers;

13 A method of dissipation of radiation induced heat in a spliced section of an air-clad fiber with a conventional fiber as in claims 7 and 12 and where said radiation is absorbed and dissipated by said radiation absorbing and dissipating nodes and said fluid.
